(19) United States
(12) Patent Application Publication
(10) Pub. No.: US 2006/0061832 A1
(43) Pub. Date: Mar. 23, 2006

(54) Method to unlock scanner carriage without user intervention

(76) Inventors: Christa Ferguson, Round Rock, TX (US); Donald Guthan, Round Rock, TX (US); Charles Morton, Leander, TX (US); Dustin Sorenson, Austin, TX (US)

Correspondence Address: HAMILTON & TERRILE, LLP, P.O. BOX 203518, AUSTIN, TX, 78720, US

(21) Appl. No.: 10/944,629

(22) Filed: Sep. 17, 2004

(51) Int. Cl. H04N 1/04

(52) U.S. Cl. 358/474

(57) ABSTRACT

A method for locking a scan carriage which includes providing an automatic scan carriage locking mechanism and automatically unlocking the scan carriage when the scan device is powered up. The automatic scan carriage locking mechanism automatically locks the scan carriage when a predetermined operating mode is detected.

### BACKGROUND OF THE INVENTION

1. Field of the Invention

The present invention relates to the field of scanner devices and more particularly to locking and unlocking of a scanner mechanism.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems. One example of an information handing system is a scanner device.

Scanner devices are often included within multifunction devices such as a printer, scanner, copier device or a printer, scanner, facsimile and copier device. Known scanner devices often include a scan lock mechanism to prevent the scanner carriage within the scan mechanism from moving or being damaged when the scanner device is moved or shipped to a customer. Scanner device suppliers often receive service calls from customers who have received a scanner device because the customers are not aware that scanner carriage should be unlocked before using the scanner device.

Accordingly, it is desirable to enable automatic unlocking and locking of the scanner carriage.

### SUMMARY OF THE INVENTION

In accordance with the present invention, an automatic scan carriage locking mechanism is provided for locking a scanner carriage automatically in a plurality of operating modes such as when the scanner device times out, is powered off or is placed into a power standby mode.

In one embodiment, as a part of the power up/power down process, the scanner is locked so that if the user decides to move the scanner device, the user can do so without damaging the scanner device.

Because this lock and unlock process is transparent to the user, the scan locking mechanism reduces or eliminates calls to the scanner device provider regarding how to unlock the scanner. Additionally, such an automatic scan carriage locking mechanism provides a positive customer experience.

In one embodiment, the invention relates to a method for locking a scan carriage which includes providing an automatic scan carriage locking mechanism and automatically unlocking the scan carriage when the scan device is powered up. The automatic scan carriage locking mechanism automatically locks the scan carriage when a predetermined operating mode is detected.

In another embodiment, the invention relates to an apparatus for locking a scan carriage which includes an automatic scan carriage locking mechanism and means for automatically unlocking the scan carriage when the scan device is powered up. The automatic scan carriage locking mechanism automatically locks the scan carriage when a predetermined operating mode is detected.

In another embodiment, the invention relates to an information handling system which includes a processor, memory coupled to the processor, a scan module coupled to the processor, and an automatic scan lock mechanism coupled to the scan module. The automatic scan carriage lock mechanism automatically locks the scan carriage when a predetermined operating mode is detected and automatically unlocks the scan carriage when the scan device is powered up.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of an environment in which a multifunction device is used.

FIG. 2 shows a flow chart of the operation of an automatic scan carriage locking mechanism.

FIG. 3 shows a perspective view of a scan carriage having a scan carriage lock engaged.

FIG. 4 shows a perspective view of a scan carriage having a scan carriage lock disengaged.

FIG. 5 show a block diagram of an example of an electrically operated locking mechanism.

FIGS. 6A and 6B show block diagrams of an example of a mechanically operated locking mechanism is shown.

### DETAILED DESCRIPTION

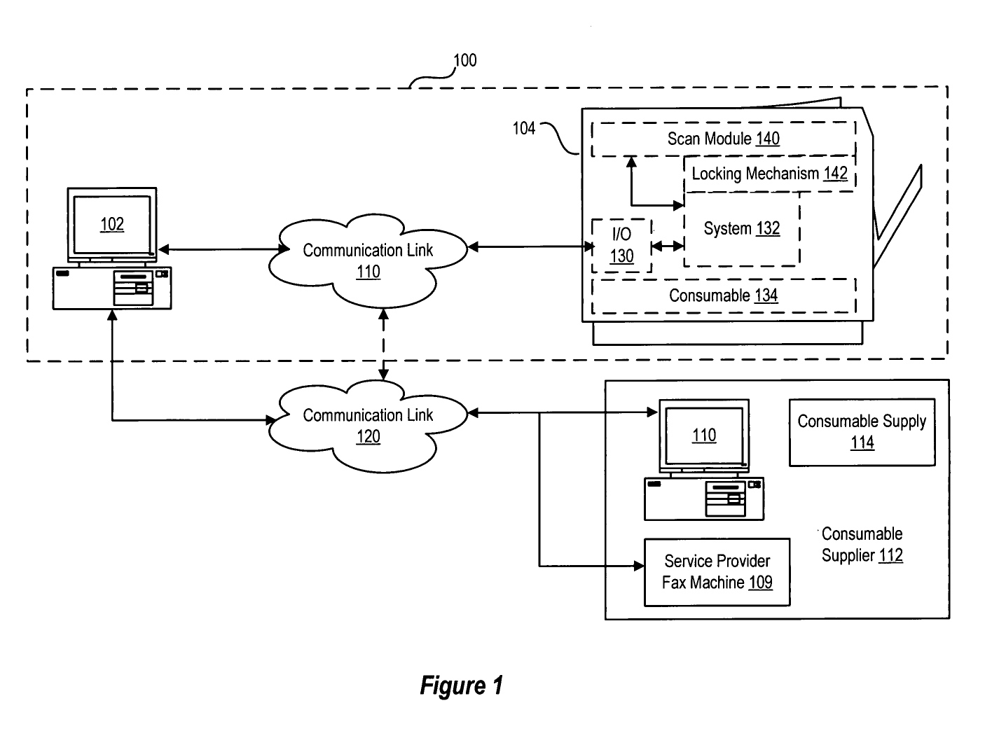

Referring to FIG. 1, a block diagram of an environment in which a multifunction device is used is shown. The environment includes a computer system 102 and a scan device 104, coupled via a communication link 110. The communication link 110 might be a printer cable, a telephone cable, a network connection or any other link which information is communicated with the fax machine 104. In one embodiment, the scan device 104 is included within a multifunction device. Other functions of the multifunction device may include a print function, a facsimile function and a copy function. Also, in one embodiment, the environment does not include a computer system 102.

The scan device 104 may be coupled to a second communication link 120. Thus, communication may occur between the scan device 104 and anything coupled to the second communication link 120 such as a services provider fax machine 109. Additionally, the computer system 102 is also connected to another computer system (e.g., a services provider computer system) 110 via a second communication link 120. The second communication link 120 may be a telephone system or some other type of network, such as the Internet. In one embodiment, the fax machine 109 and the computer system 110 are owned and operated by a scan device service provider 112. In this example, the scan device service provider 112 provides service for the scan device 104.

The device 104 includes an input output (I/O) port 130 and a control system 132 as well as at least one consumable 134 if the scan device is included within a multifunction device. The I/O port 130 facilitates communications between the scan device 104 and other devices connected to the communications link 110. The control system 132 provides the scan device 104 with certain control functionality. The control system 132 includes a processor and memory coupled to the processor. The scan device 104 also includes a scan module 140 as well as an automatic scan locking mechanism 142. The scan module 140 includes a scan carriage. The scan carriage generally represents the moving portion of the scan module.

The consumable 134 represents any component in the multifunction device that is subject to depletion through use of the multifunction device. For example, the consumable 134 may be a toner cartridge or an inkjet cartridge, etc. The scan device service provider maintains a supply 114 of replacement consumables 134.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components. Accordingly, the scan device 104 is an example of an information handling system

The locking mechanism 142 includes an automatic scan carriage locking mechanism for automatically locking a scanner carriage within the scan module 140 in a plurality of operating modes. The operating modes in which the locking mechanism locks the scan carriage include one or more of when the scanner device 104 times out, is powered off, is placed into a power standby mode or is disconnected from a power source. As a part of the power up/power down process, the scanner module 140 is locked so that if the user decides to move the scanner device 104, the user can do so without damaging the scanner module 140.

Because this lock and unlock process is transparent to the user, the scan locking mechanism reduces or eliminates calls to the scanner device provider regarding how to unlock the scanner. Additionally, such an automatic scan carriage locking mechanism provides a positive customer experience.

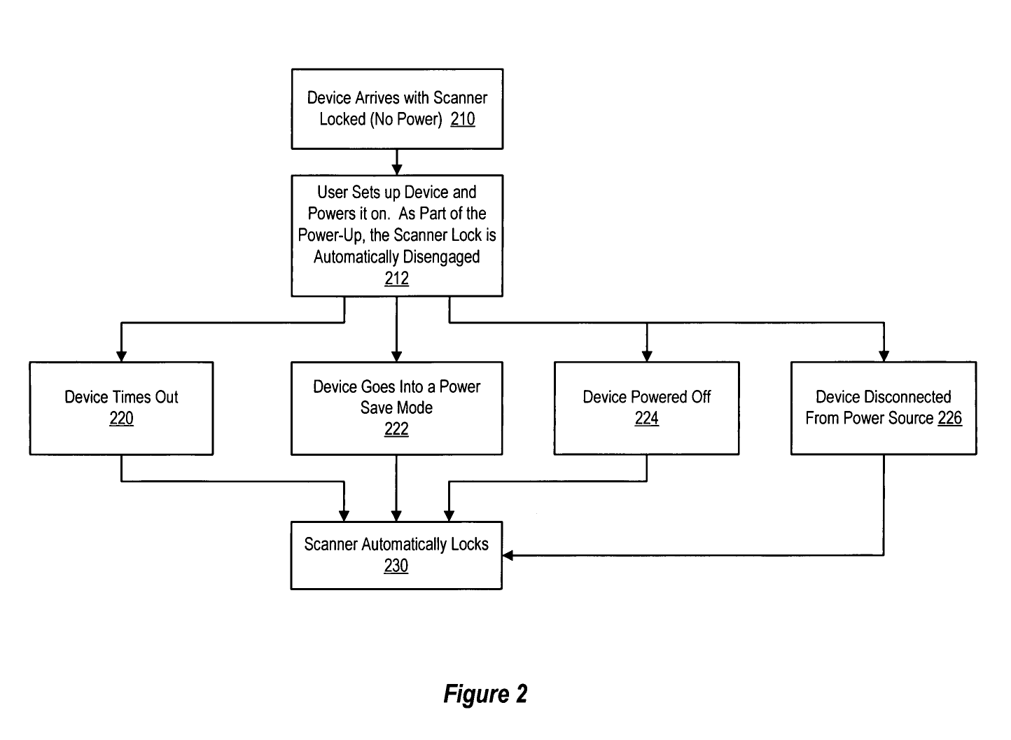

Referring to FIG. 2, a flow chart of the operation of the automatic scan locking mechanism 142 is shown. More specifically, when a scan device 104 arrives from a scan device supplier, the scanner module is locked at step 210. When a user sets up the scan device, the device is configured to power on (e.g., the scanner device 104 is connected to a power source via, e.g., a power converter device) at step 212. As part of the power up sequence, the automatic scan lock mechanism 142 disengages the scan carriage locking mechanism. The automatic scan lock mechanism 142 then determines whether at least one operating mode condition occurs. For example, the automatic scan lock mechanism 142 determines whether the scan device times out from inactivity at step 220, whether the scan device goes into a power save mode of operation at step 222, whether the scan device is powered off at step 224 or whether the scan device is disconnected from a power source at step 226. The automatic scan lock mechanism then automatically locks the scan module 140 if a predetermined operating mode condition occurs at step 230.

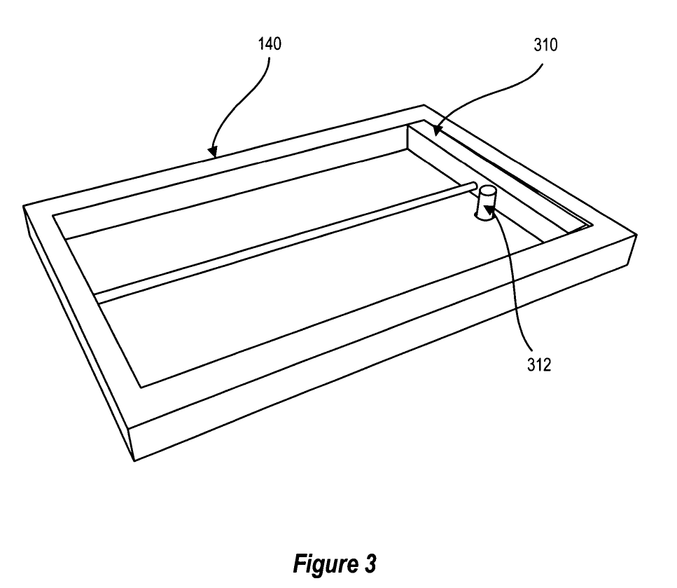

FIG. 3 shows a perspective view of a scan carriage having a lock engaged. More specifically, a scanner module 140 includes a scanner carriage 310 as well as a lock 312. When locked via the lock 312, the scanner carriage 310 is prevented from moving within a scan portion of the scan module 140.

The lock 312 is a normally closed device so that when the locking mechanism is not actuated, the lock automatically locks the scan carriage 310. When the locking mechanism is actuated, the lock automatically unlocks the scan carriage 310.

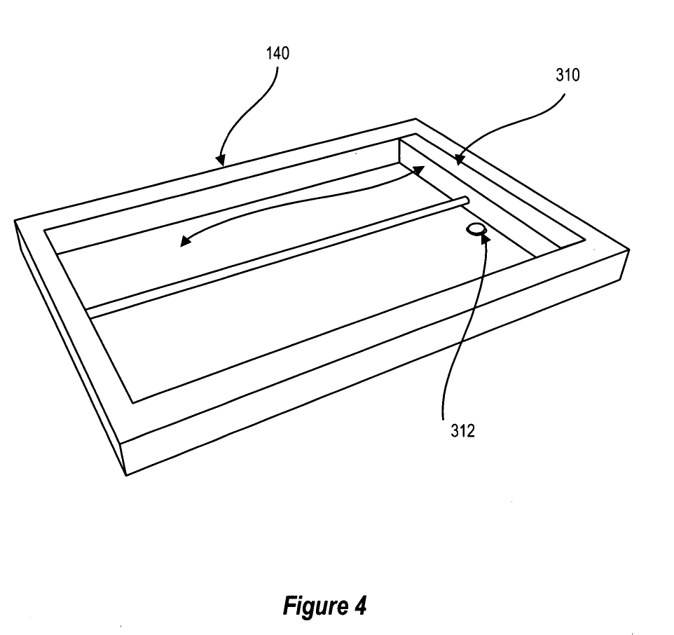

FIG. 4 shows a perspective view of a scan carriage having a lock disengaged. More specifically, hen unlocked via the lock 312, the scanner carriage 310 is allowed to move within a scan portion of the scan module 140.

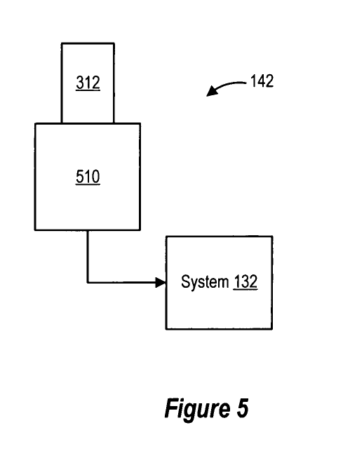

Referring to FIG. 5, an example of an electrically operated locking mechanism is shown. More specifically with an electrically operated locking mechanism, the locking mechanism includes the lock 312 which actuated by a solenoid and spring mechanism 510. When powered on, the solenoid pulls the post downward, freeing the scan carriage to scan. When power is off or the scan device 104 enters power save mode as determined by the control system 132, the solenoid is no longer activated and the spring pushed the lock 312 back into the “locked” position.

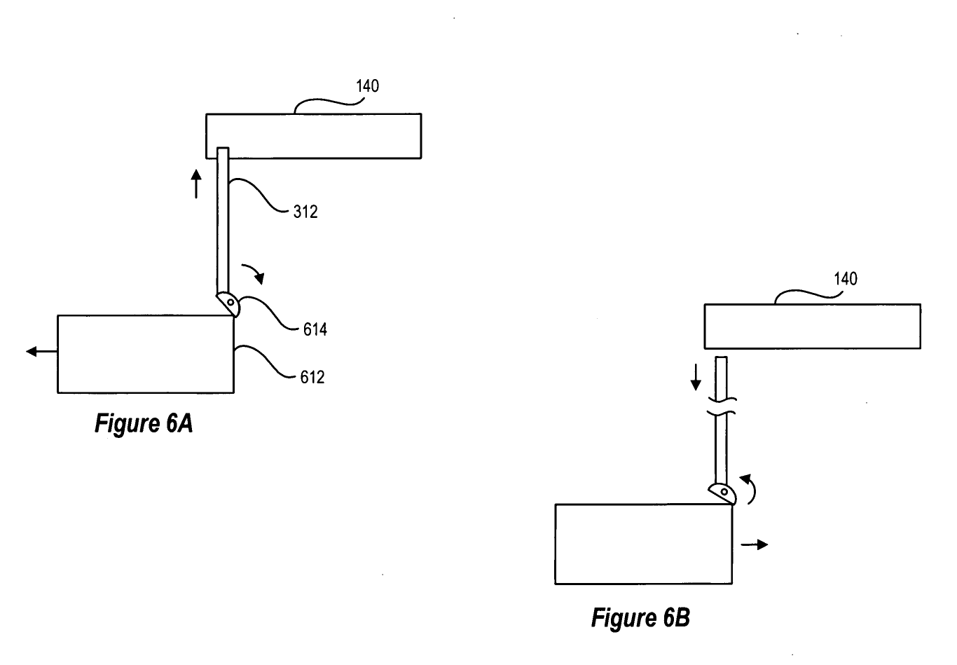

Referring to FIGS. 6A and 6B, an example of a mechanically operated locking mechanism is shown. More specifically, with a mechanically operated locking mechanism, the lock 312 is mechanically coupled to a power source such as a power brick 612 via a lever 614 such as a plunger or a cable so that when the power source 612 is disconnected from the scan device 312, the lock 312 engages. When the power source is connected to the scan device, the lock 312 disengages.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Also for example, while particular mechanisms for unlocking the scanner mechanism without user intervention are set forth, other mechanisms are within the scope of the invention.

Also for example, it will be appreciated that other types of printer consumables in addition to inkjet cartridges may include multiple projection key modules.

Consequently, the invention is intended to be limited only by the spirit and scope of the appended claims, giving full cognizance to equivalents in all respects.

What is claimed is:

1. A method for locking a scan carriage comprising:
providing an automatic scan carriage locking mechanism, the automatic scan carriage locking mechanism automatically locking the scan carriage when a predetermined operating mode is detected; and,
automatically unlocking the scan carriage when the scan device is powered up.

2. The method of claim 1 wherein
the locking and unlocking of the scan module is transparent to a user.

3. The method of claim 1 wherein
the predetermined operating mode includes a device time out operating mode.

4. The method of claim 1 wherein
the predetermined operating mode includes a device power save operating mode.

5. The method of claim 1 wherein
the predetermined operating mode includes a device power off operating mode.

6. The method of claim 1 wherein
the predetermined operating mode includes a disconnecting the device from a power source operating mode.

7. The method of claim 1 wherein
the automatic scan carriage locking mechanism is a normally closed device.

8. The method of claim 1 wherein
the automatic scan carriage locking mechanism is mechanically actuated.

9. The method of claim 1 wherein
the automatic scan carriage locking mechanism is electrically actuated.

10. An apparatus for locking a scan carriage comprising:
an automatic scan carriage locking mechanism, the automatic scan carriage locking mechanism automatically locking the scan carriage when a predetermined operating mode is detected; and,
means for automatically unlocking the scan carriage when the scan device is powered up.

11. The apparatus of claim 10 wherein
the locking and unlocking of the scan module is transparent to a user.

12. The apparatus of claim 10 wherein
the predetermined operating mode includes a device time out operating mode.

13. The apparatus of claim 10 wherein
the predetermined operating mode includes a device power save operating mode.

14. The apparatus of claim 10 wherein
the predetermined operating mode includes a device power off operating mode.

15. The apparatus of claim 10 wherein
the predetermined operating mode includes a disconnecting the device from a power source operating mode.

16. The apparatus of claim 10 wherein
the automatic scan carriage locking mechanism is a normally closed device.

17. The apparatus of claim 10 wherein
the automatic scan carriage locking mechanism is mechanically actuated.

18. The apparatus of claim 10 wherein
the automatic scan carriage locking mechanism is electrically actuated.

19. An information handling system comprising:
a processor;
memory coupled to the processor;
a scan module coupled to the processor;
an automatic scan lock mechanism coupled to the scan module, the automatic scan carriage lock mechanism automatically locking the scan carriage when a predetermined operating mode is detected and automatically unlocking the scan carriage when the scan device is powered up.

20. The information handling mechanism of claim 19 wherein
the locking and unlocking of the scan module is transparent to a user.

21. The information handling mechanism of claim 19 wherein
the predetermined operating mode includes a device time out operating mode.

22. The information handling system of claim 19 wherein
the predetermined operating mode includes a device power save operating mode.

23. The information handling system of claim 19 wherein
the predetermined operating mode includes a device power off operating mode.

24. The information handling system of claim 19 wherein
the predetermined operating mode includes a disconnecting the device from a power source operating mode.

25. The information handling system of claim 19 wherein
the automatic scan lock mechanism is a normally closed device.

26. The information handling system of claim 19 wherein
the automatic scan lock mechanism is mechanically actuated.

27. The information handling system of claim 19 wherein
the automatic scan lock mechanism is electrically actuated.
